(19) United States
(12) Patent Application Publication
(10) Pub. No.: US 2021/0080262 A1
(43) Pub. Date: Mar. 18, 2021

(54) SELF-SEATING SYSTEM AND METHOD

(71) Applicants: Terrance J O'Shea, Mission Viejo, CA (US); Patrick Nguyen, New Orleans, LA (US); Tom E Pearson, Beaverton, OR (US)

(72) Inventors: Terrance J O'Shea, Mission Viejo, CA (US); Patrick Nguyen, New Orleans, LA (US); Tom E Pearson, Beaverton, OR (US)

(21) Appl. No.: 16/568,955

(22) Filed: Sep. 12, 2019

(51) Int. Cl. G01C 21/20; G06F 3/0488; H04W 4/33; H04W 4/38

(52) U.S. Cl. CPC G01C 21/206; H04W 4/38; H04W 4/33; G06F 3/0488

(57) ABSTRACT

A self-seating system is described. The self-seating system includes a guest interface for communicating with an arriving guest information relating to a seating assignment and a processing device communicating with the guest interface. The self-seating system also includes more than one directional display providing guidance to the guest as to the location of their seating assignment. The directional displays is selectively activated and deactivated through communication and signaling by the processing device. The self-seating system further includes a seating sensor communicating with the processing device as to when a guest is seated at a particular location.

### BACKGROUND

Sports venues, theaters, other show venues, restaurants, and other venues require hostesses or ushers for guest seating either in reserved seats or seats chosen by the venue personnel or automated seating management systems at the venue. Conventionally, in restaurants host seating is done by a hostess asking how many people are in the party and selecting a table on their own table map display. The host would then escort the guest to the table and then mark the table as being occupied on a host seating map.

Conventional self-seating host displays can offer a table map for the guest to pick from, however the table map does not direct the guest directly to the table. This can lead to guest frustration with the guest left on their own searching for the table. Extra time may then be needed as the guest negotiates the restaurant to find their table, or worse ends up sitting at the wrong table.

Conventionally, self-seating displays may not include a table management system where the manager can select certain criteria before providing a table that is available. These criteria include closed sections of the restaurant, load balancing for wait staff, pending areas of restaurant to be closed, and current pending and existing reservations.

Thus, there is a need for self-seating systems in restaurants and the like that avoid the utilization of a live hostess to guide guests to their table. Further, there is a need for self-seating systems that help guests be directed directly to their table via automated means. Further still, there is a need for self-seating systems which automate table or seating management. Yet further still, there is a need for self-seating systems that automate all facets of seating management and guest seating.

### SUMMARY

An exemplary embodiment relates to a self-seating system. The self-seating system includes a guest interface for communicating with an arriving guest information relating to a seating assignment and a processing device communicating with the guest interface. The self-seating system also includes more than one directional display providing guidance to the guest as to the location of their seating assignment. The directional displays is selectively activated and deactivated through communication and signaling by the processing device. The self-seating system further includes a seating sensor communicating with the processing device as to when a guest is seated at a particular location.

Another exemplary embodiment relates to a method of self-seating. The method includes providing information to a guest and receiving information relating to a seating assignment from a guest. The method also includes calculating, by a processing device, a path for the guest to follow to an assigned seat and activating more than one directional displays to indicate the path to the guest. Further, the method includes sensing the arrival of the guest at the seating assignment.

Yet another exemplary embodiment relates to a system for self-seating. The system includes a means for providing information to a guest and a means for receiving information relating to a seating assignment from a guest. The system also includes a means for calculating, by a processing device, a path for the guest to follow to an assigned seat and a means for activating more than one directional displays to indicate the path to the guest. Further, the system includes a means for sensing the arrival of the guest at the seating assignment.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE DRAWINGS

FIG. 1 is an exemplary embodiment of a self-seating system.

FIG. 2 is an exemplary embodiment of a process for a self-seating system.

FIG. 3 is another exemplary embodiment of a self-seating system.

The use of the same symbols in different drawings typically indicates similar or identical items unless context dictates otherwise.

### DETAILED DESCRIPTION

Many restaurants are looking at ways to save on labor costs while still providing timely and efficient service for their guests. Exemplary embodiments relate to a self-service hostess system that allows guests to choose a table from a table availability display. Once a table is chosen a series of lighted indicators and displays lead the guest to their table. Use of an exemplary system like this eliminates the labor cost of a hostess for seating guests.

Sports, theater, or other shows require a hostess or usher for guest seating. Using exemplary embodiments of the systems described can eliminate the cost for a seating hostess/usher saving labor and providing faster service to the guest since it can seat more than one guests at once using different color of path indicators for each guest.

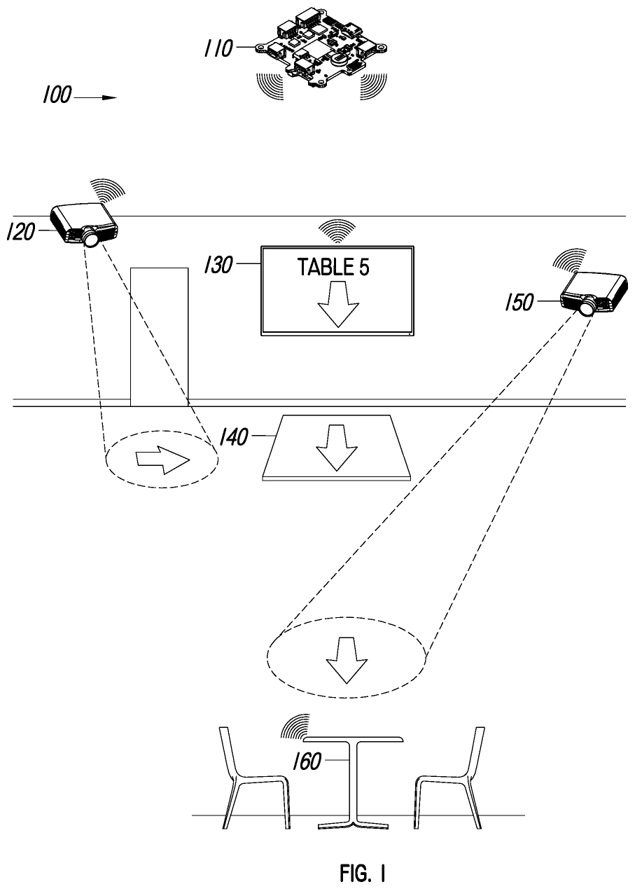

Referring now to FIG. 1, an exemplary system 100 of a self-seating system is depicted. Self-seating system 100 is designed to take the place of a human host or hostess. System 100 includes a micro-controller 110 which has wired or wireless communications interface for communicating with other devices of system 100 including but not limited to light projectors 120 and 150, table display sign 130, and table sensor 160.

As guests arrive and interface with the self-seating system 100, micro-controller 110 calculates the best path for a guest to proceed from a self-seating hostess station to their table. Micro-controller 110 activates displays of indicators describing the direction and location of the table selected. Once the guest arrives at their table, the indicators are then turned off via a timer or in conjunction with a table occupied sensor 160 or smart button located at the table. The indicator can also be turned off through a manager override in the system.

In an exemplary operation, once guests are assigned a table by a self-seating hostess station, a projector 120 is activated to provide a directional indicator to the guest. The directional indicator may be produced from a projector 120 such as but not limited to an LED projector or laser projector among other forms of projectors. The indicator may be, but is not limited to, an arrow displayed on the floor, wall, or other surface. Also, micro-controller 110 may communicate with video displays, such as video display 130, which may be posted on walls and the like. Video display 130 may provide information and directional information. In accordance with an exemplary embodiment, display 130 may provide a table number being assigned to the guests but also directional information such as but not limited to an arrow. A display such as display 140 may also be provided embedded or provided on the floor for providing directional information to guests.

In accordance with an exemplary embodiment, it may be desirable to provide multiple indicators from multiple projectors, such as additional projector 150, thereby illuminating an entire pathway to the table. There is no limit to the number of projectors that need to be used to provide adequate directional information to self-guide patrons to their assigned table.

In accordance with exemplary embodiments, the indicators may include, but are not limited to High output LEDs, projected symbols such as arrows from the ceiling or walls, LEDs in and on the floor and in floormats, video displays or audible speakers.

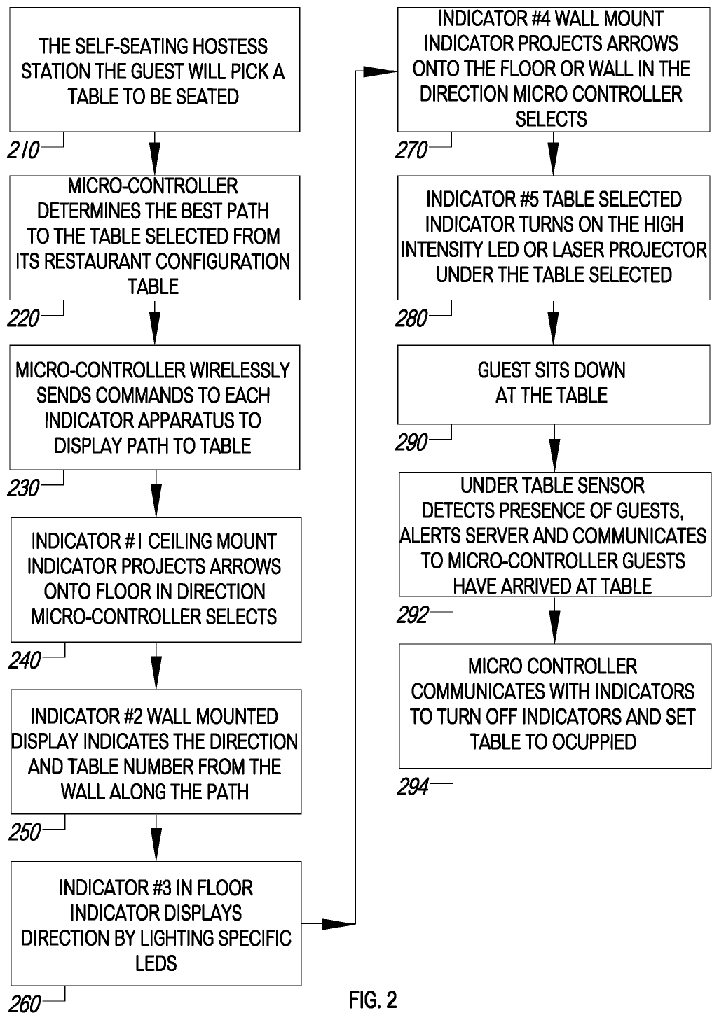

Referring now to FIG. 2, an exemplary process flow diagram is depicted for the self-seating system as described above. The exemplary process begins with guests interfacing with a self-seating hostess station where the guests either choose or a table is automatically chosen for the guests (process 210). Once the table is chosen, the micro-controller determines the best path to the table selected from its restaurant configuration table (process 220). The micro-controller then sends commands to each indicator apparatus to display a path to the chosen table (process 230). In the next exemplary steps, a patron is guided along a path to their table. Any of and any combination of process steps 240, 250, 260, 270, and 280 may occur depending on the configuration for a particular restaurant. One or more ceiling mount indicators may project arrows onto the floor showing a directional indicator selected by the microcontroller (process 240). A wall mounted display may indicate the direction to and table number from the wall along the path (process 250). An in-floor indicator will display a direction by lighting specific LEDs along a path (process 260). A wall mount indicator may project arrows onto the floor or wall in a direction selected by the microcontroller (process 270). A table selected indicator, which may be a high intensity LED or laser projector, will illuminate the selected table from above or beneath (process 280). As the guest follows the supplied indicators, the guest arrives at the designated table and sits down (process 290). An under-table sensor then detects the presence of guests, alerts a server, and communicates to the micro-controller that guests have arrived at the table (process 292). The micro-controller then communicates with indicators to turn off the indicators and set the table to occupied in the self-seating system (process 294).

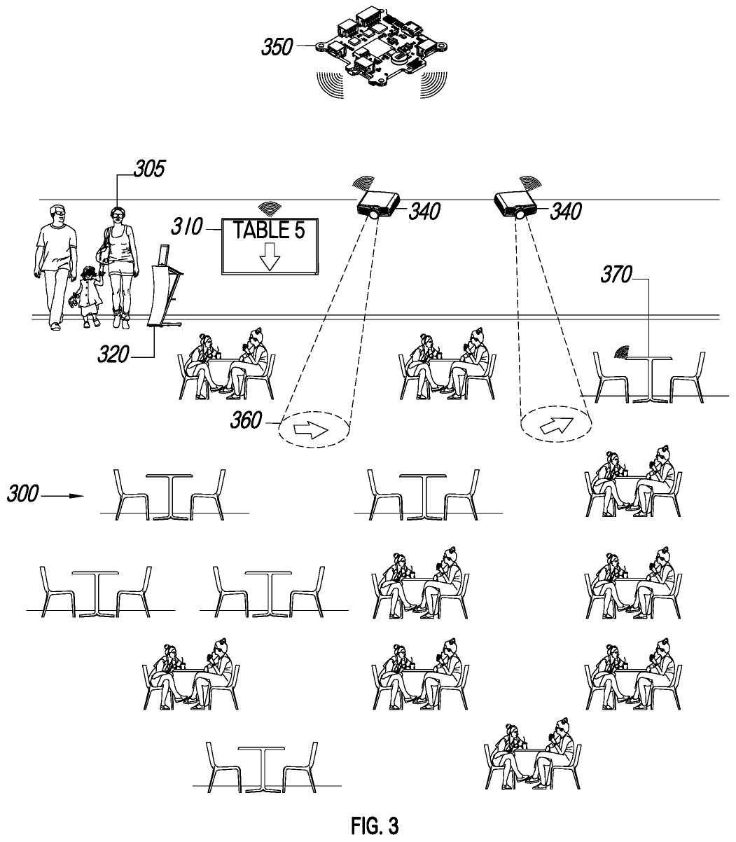

Referring now to FIG. 3, a self-seating system 300 is depicted. Self-seating system 300 includes an automated hostess station 320 that is used for patrons 305 to select a table and have it displayed on a wall display 310 with a general directional indicator as to how to get there. Patrons 305 interface with the hostess system 320 via a touch screen display or the like. Once patrons 305 select a table, the selection may appear on display 310 and micro-controller 350 calculates a path to the table. Once calculated, micro-controller 350 activates devices (projectors 340, or other devices) to illuminate indicators 360 for patrons to follow a path to their table 370. When patrons arrive at table 370 a table presence sensor communicates with micro-controller 350 to turn off displays relating to their path.

Self-seating hostess system may be a wired or wireless system or some combination thereof. Hostess-station 320 may also be replaced by any other type of interface including but not limited to a computer, a touch screen display, a personal mobile device such as a smartphone running an app which communicates via the internet with micro-controller 100. Exemplary embodiments may be used as a self-seating hostess at any establishment or business that requires guest seating such as sporting, theater, or other events that currently requires a hostess or ushers to seat guests. In an exemplary embodiment, the system can be linked to sound or tactile devices for the visual or hearing-impaired guests to indicate path and direction. Further, in an exemplary embodiment, the system can be linked into the music being played in the establishment to create a visual ambiance of flashing and fading projected icons. Further, exemplary embodiments may be linked to other sensors in the restaurant that detects table occupancy or guest presence.

In setting up a restaurant with the self-seating system described, restaurants will need to configure the existing hostess station with a customer facing display welcoming the guest to the restaurant and asking them to select a table to be seated. A hostess will no longer be required to seat guests and may not be needed at all with this system. Path Indicators will be installed in the ceiling, flooring, walls and video displays.

Once installed, the system can provide restaurants with labor cost savings by eliminating or reducing seating host costs. Further, the system can provide better guest satisfaction with the ability of the guest to choose their own table. Further still, the system described can provide better restaurant table management. This system offers available tables on a host table map that meets manager defined criteria such as number of persons in the party, waiters service sections that are open and have capacity, multimedia seating areas, high chair needs and other factors considered before offering a table. All of these features can be configured for a specific restaurant and by a manager trying to provide a specific experience for their customers.

In accordance with exemplary embodiments, the system can also offer a better guest reservation system by linking the restaurant reservation application directly to the self-service hostess system allowing a full comprehensive reservation system from self-reservation to self-seating at the restaurant. A guest link through a phone app via the restaurant reservation system to reserve a table may also be provided and when they arrive, they can simply pick the table reserved from the self-seating host display and be led to their table and seated by the table path indicators.

When this system is linked to a table occupied sensor, the indicators to the table for the guest may be turned off after the table occupied sensor detects the guest has arrived at the table.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A self-seating system, comprising:
a guest interface for communicating with an arriving guest information relating to a seating assignment;
a processing device communicating with the guest interface;
more than one directional display providing guidance to the guest as to the location of their seating assignment, the directional displays being selectively activated and deactivated through communication and signaling by the processing device; and
a seating sensor communicating with the processing device as to when a guest is seated at a particular location.

2. The self-seating system of claim 1, wherein the guest interface comprises a touch screen display device.

3. The self-seating system of claim 1, wherein the guest interface comprises a personal mobile device running an app.

4. The self-seating system of claim 1, wherein the guest interface comprises a seating map.

5. The self-seating system of claim 1, wherein the processing device comprises a micro-controller with wireless communication capabilities

6. The self-seating system of claim 1, wherein the at least one of the more than one directional displays comprises a video display.

7. The self-seating system of claim 1, wherein the at least one of the more than one directional displays comprises a light projector.

8. The self-seating system of claim 1, wherein the at least one of the more than one directional displays comprises a laser projector.

9. The self-seating system of claim 1, wherein the seating sensor comprises a table sensor configured to sense when guests are seated at a particular table.

10. A method of self-seating: comprising:
providing information to a guest;
receiving information relating to a seating assignment from a guest;
calculating, by a processing device, a path for the guest to follow to an assigned seat;
activating more than one directional displays to indicate the path to the guest;
sensing the arrival of the guest at the seating assignment.

11. The method of claim 10, further comprising:
deactivating the more than one directional display.

12. The method of claim 10, further comprising:
selecting a specific seating assignment, by the guest on a touch sensitive display.

13. The method of claim 10, wherein the at least one of the more than one directional displays comprises a video display.

14. The method of claim 10, wherein the at least one of the more than one directional displays comprises a light projector.

15. The method of claim 10, wherein the at least one of the more than one directional displays comprises a laser projector.

16. The method of claim 10, wherein the sensing comprises sensing by a table sensor configured to sense when guests are seated at a particular table.

17. A system for self-seating, comprising:
a means for providing information to a guest;
a means for receiving information relating to a seating assignment from a guest;
a means for calculating, by a processing device, a path for the guest to follow to an assigned seat;
a means for activating more than one directional displays to indicate the path to the guest;
a means for sensing the arrival of the guest at the seating assignment.

18. The system of claim 17, further comprising:
a means for deactivating the more than one directional display.

19. The system of claim 17, further comprising:
a means for selecting a specific seating assignment, by the guest on a touch sensitive display.

20. The system of claim 10, wherein at least one of the more than one directional displays comprises a light projector.
